(19) United States
(12) Patent Application Publication
(10) Pub. No.: US 2002/0192017 A1
(43) Pub. Date: Dec. 19, 2002

(54) Wiper blade coupler with shim

(76) Inventors: Jerry M. Rosenstein, Parkland, FL (US); Vambi R. Tolentino, Coconut Creek, FL (US)

Correspondence Address: Douglas A. Mullen, Dickinson Wright PLLC, Suite 800, 1901 L. Street NW, Washington, DC, 20036, US

(21) Appl. No.: 09/878,908

(22) Filed: Jun. 13, 2001

(51) Int. Cl. F16B 1/00; B25G 3/28; F16G 11/00

(52) U.S. Cl. 403/279

(57) ABSTRACT

The present invention is directed to a shim for a wiper arm in a windshield wiper blade assembly. The shim includes a base having a deck and an arcuate extension extending from the deck. The base defines a hook-shaped upper bearing surface and a hook-shaped lower bearing surface. The shim also includes first and second side walls as well as a pair of opposed tabs. The first and second side walls extend from the base and are spaced from one another to define a channel. The opposed tabs extend from the side walls into the channel for coupling the shim to the wiper arm. The present invention is also directed to a wiper arm assembly with a hook-shaped wiper arm and a shim such as that described above.

### BACKGROUND OF THE INVENTION

The present invention relates generally to the connection of a windshield wiper blade to a wiper arm and, more particularly, to a wiper blade connector assembly having a shim that is connectable to a hook arm to change the effective shape of the hook and allow connection of the hook arm to a connector fixed to the wiper blade.

Windshield wiper arms are used to connect the wiper blade to the wiper drive. The wiper arm configurations of motor vehicles presently in service vary widely and include pin, hook and bayonet shaped ends. Wiper blade manufacturers have attempted to simplify manufacturing and distribution demands by designing universal connector assemblies that permit releasable connection of a windshield wiper blade to multiple wiper arm configurations.

While many examples of these connector assemblies are available, one such assembly is illustrated and described in U.S. Pat. No. 5,807,016 issued Sep. 15, 1998 to Herring et al., entitled “Connection Of Windshield Wiper Blades.” The '016 assembly includes a connector configured to selectively connect a pin-type and smaller hook slot wiper arm to the windshield wiper blade and an adapter that is physically separate from and directly attachable to the connector to permit connection of the wiper blade to a larger hook slot wiper arm. To adapt the connector assembly to accommodate the larger hook slot wiper arm, the adapter or shim of the '016 patent must be fixed to the connector by disposing a pair of arms extending from the bottom rear portion of the shim into an opening formed in the top of the connector. When the shim is fixed to the connector piece, the assembly accommodates a larger hook arm, particularly a 9 mm×4 mm hook slot arm (also sometimes referred to as a ¾ inch hook slot arm).

A replacement wiper blade with a connector assembly of the general type described in the '016 patent is commonly shipped with the connector piece attached to the wiper blade and the shim or adapter included separately in the package. If the shim is needed for coupling the wiper blade to a large hook arm, the consumer must fix the shim to the connector. If a consumer fixes the shim to the connector and then determines that the wiper arm includes a connector other than a large hook arm, the consumer must remove the shim from the connector. Due to the configuration of the shim and connector of the '016 patent, removal of the shim from the connector is very difficult. Accordingly, consumers may be frustrated with the inability to easily connect a wiper arm to the wiper blade if the shim is mistakenly fixed to the connector.

### SUMMARY OF THE INVENTION

In view of the above, a need exists for a wiper blade coupler assembly having a shim that is configured to be directly attached to a hook shaped wiper arm to change the effective shape of the arm. The shim is connectable to the arm in a manner that provides a secure assembly when the arm is connected to the wiper blade yet permits a consumer to easily remove the shim from the arm if desired. Moreover, the shim, being connectable to the wiper arm rather than requiring a specific snap-fit or other direct connection to the connector, cooperates with the hook arm to provide a hook-shaped profile that approximates the configuration and dimension of a smaller hook arm whereby the shimmed larger hook arm may be connectable to a variety of connectors.

In general, the present invention is directed to a shim for a wiper arm in a windshield wiper blade assembly. The shim includes a base having a deck and an arcuate extension extending from the deck. The base defines a hook-shaped upper bearing surface and a hook-shaped lower bearing surface. The shim also includes first and second side walls as well as a pair of opposed tabs. The first and second side walls extend from the base and are spaced from one another to define a channel. The opposed tabs extend from the side walls into the channel for coupling the shim to the wiper arm. The present invention is also directed to a wiper arm assembly with a hook-shaped wiper arm and a shim such as that described above.

Further scope of applicability of the present invention will become apparent from the following detailed description, claims, and drawings. However, it should be understood that the detailed description and specific examples, while indicating preferred embodiments of the invention, are given by way of illustration only, since various changes and modifications within the spirit and scope of the invention will become apparent to those skilled in the art.

### BRIEF DESCRIPTION OF THE DRAWINGS

The present invention will become more fully understood from the detailed description given here below, the appended claims, and the accompanying drawings in which:

FIG. 1 is a perspective view of a wiper blade assembly according to the present invention.

FIG. 2 is a perspective view of the shim shown in FIG. 1;

FIG. 3 is a top elevational view of the shim shown in FIG. 2;

FIG. 4 is a sectional view of the shim taken along the line 4-4 shown in FIG. 3;

FIG. 5 is a sectional view of the shim taken along the line 5-5 shown in FIG. 3;

FIG. 6 is a rear elevational view of the shim shown in FIG. 2;

FIG. 7 is a sectional view of the shim taken along the line 7-7 shown in FIG. 3; and

FIG. 8 is a sectional view of the hook arm and shim taken along a line similar to that illustrated in FIG. 4.

### DETAILED DESCRIPTION OF THE PREFERRED EMBODIMENT

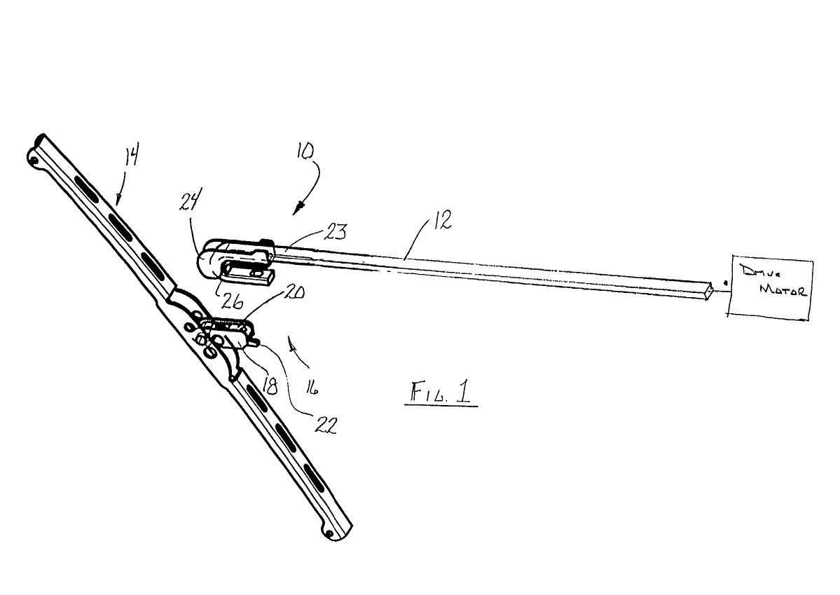

A windshield wiper assembly 10 according to the present invention is generally illustrated in FIG. 1 to include a wiper arm 12, a wiper blade 14, and a coupler assembly 16 for connecting the wiper arm to the wiper blade. In general, the windshield wiper assembly 10 is part of a wiper system that also includes a linkage assembly connecting the wiper arm to the windshield wiper drive motor. The coupler assembly includes a multi-arm connector 18 that, as is generally known in the art, is coupled to the bridge rivet of the wiper blade, and configured to accommodate a number of different types of wiper arms. The connector 18 shown in the drawings is manufactured and distributed by Pylon Manufacturing Corp. of Deerfield Beach, Fla., the assignee of the present invention, is referred to as the Talon™ Bracket, and is representative of available multi-arm connectors. The connector 18 is configured to alternatively couple three-sixteenth or one-quarter inch pin-type wiper arms, a bayonet-type wiper arm, and a smaller (e.g., 9 mm×3 mm) hook arm to a windshield wiper blade. With regard to the smaller hook arm, the connector 18 includes a channel 20 extending between the connector side walls and sized to receive and laterally restrain the hook of the wiper arm. The connector also includes a mechanism for releasably coupling the hook arm to the connector, such as the movable tabbed beam described in the '016 patent to Herring et al. and the raised portion and stopper configuration described in U.S. Pat. No. 5,289,608 issued Mar. 1, 1994 to Kim and entitled “Windshield Wiper Frame Connector With Accommodates Different Size Wiper Arms,” the disclosures of which are hereby incorporated by reference. The illustrated embodiment is shown to include a movable tabbed beam 22 (FIG. 1) similar to that shown in the '016 patent, Pylon's own Talon™ bracket, and other devices generally known in the art. Those skilled in the art will appreciate that a variety of alternative connector configurations may be used with the present invention without departing from the scope of the invention as defined by the appended claims.

The coupler assembly 16 also includes a shim 24 that is configured to be directly attached to a larger hook arm to permit coupling of the larger arm to the connector 18. Without the shim 24, the hook 26 of the wiper arm is too large for connection directly to the connector 18. Once the shim 24 is coupled to the hook 26 in the manner described below, the shim and hook cooperate to present a modified hook profile that imitates a smaller hook arm that is accommodated by the illustrated connector 18. Accordingly, the shim 24 of the present invention provides a simple and easy-to-use device that permits larger hook arms to be coupled to a windshield wiper blade. In addition to the overall simplicity of the device, the shim 24 provides numerous advantages over prior art connector assemblies including, for example, providing a connection system that is more intuitive to the consumer, providing a secure coupling of the shim 24 to the hook arm 26 while permitting relatively easy disassembly of the shim from the wiper arm if the shim is mistakenly connected, and a design that is easily adaptable for widespread use with a variety of connector configurations and wiper arm sizes.

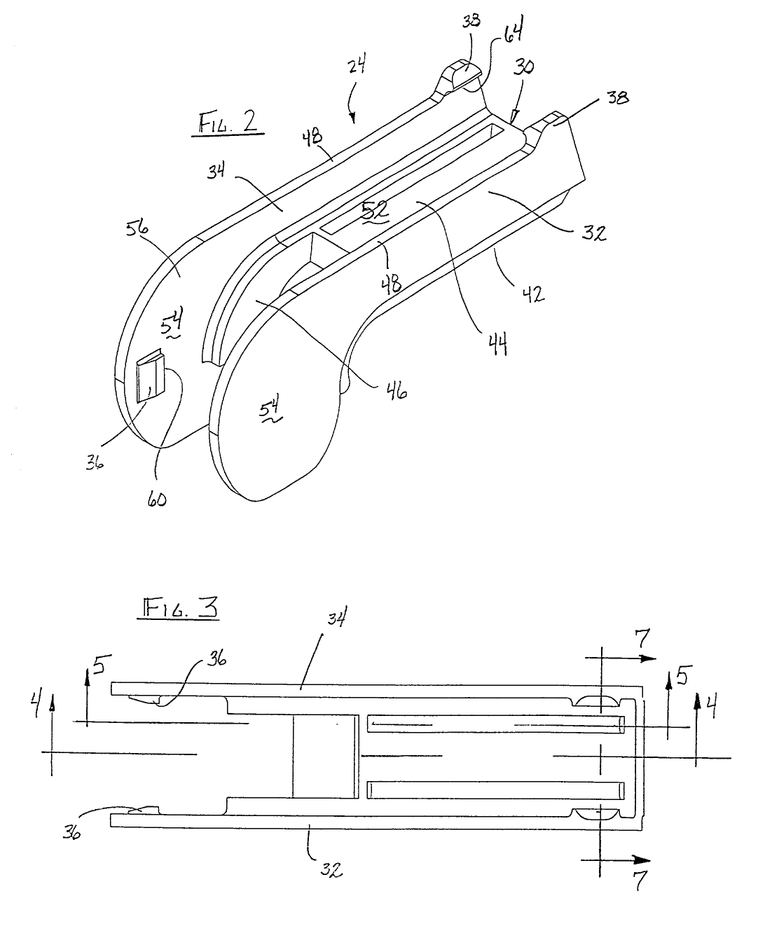

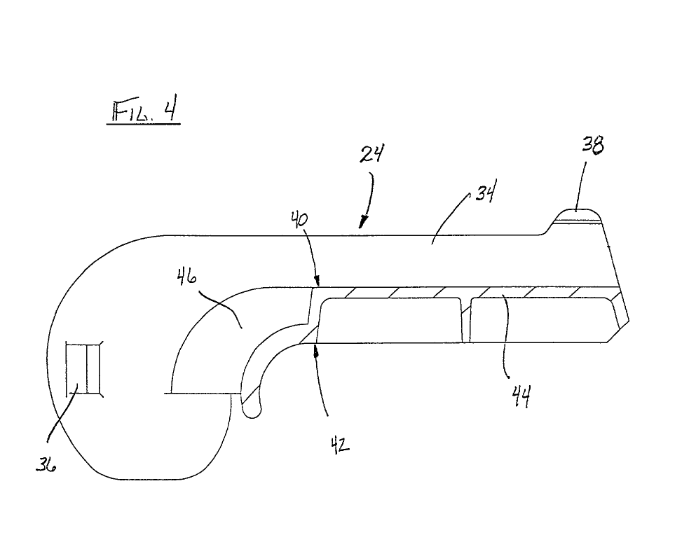

A representative configuration of the shim 24 is illustrated in FIGS. 2-6. The shim 24 includes a base 30, first and second side walls 32 and 34, and front and rear pairs of retaining tabs 36 and 38, respectively. The base 30 includes upper and lower hook-shaped bearing surfaces 40 and 42, respectively, that extend along a rear deck 44 and a forward arcuate extension 46. First and second side walls 32 and 34 are each formed integral with the base 30 to extend upwardly from the upward bearing surface 40 and terminating at a top face 48. The first and second side walls 32 and 34 are spaced from one another a predetermined width 50 (FIG. 6) to define a channel 52 therebetween and also extend forward of the arcuate extension 46 to define forward wing portions 54. The channel width 50 is preferably constant along the channel and, in the described embodiment, is about or slightly larger than the 9 mm width of a 9 mm×4 mm hook arm. However, those skilled in the art will appreciate that the channel width 50 may be varied to accommodate other hook arm sizes.

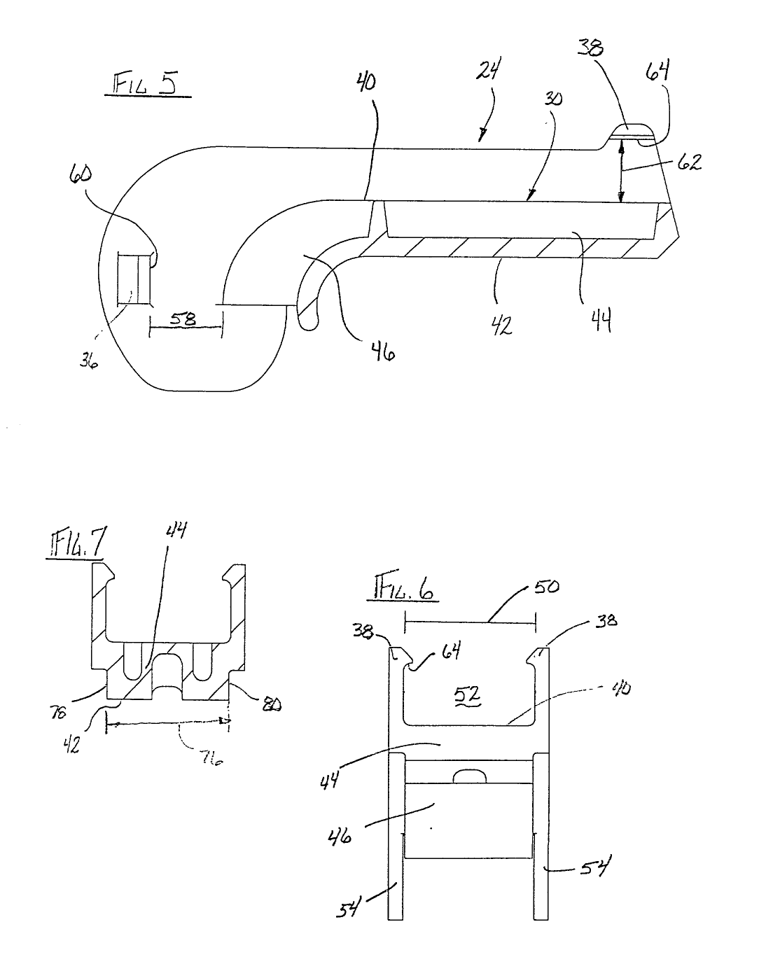

Each of the front pair of retaining tabs 36 extend inwardly from an inner surface 56 of a wing portion and include an engaging surface 60 spaced from the closest point on the arcuate section of the upper bearing surface 40 to define a gap 58 (FIG. 5). Similarly, a spacing 62 is present between the engagement surface 64 of the rear pair of tabs 38 and the closest portion of the upper bearing surface defined by the deck 44. The forward pair of tabs 36 are positioned vertically below the rear pair of tabs 38 and the engagement surfaces 60 and 64 of each pair of tabs are oriented substantially perpendicular to one another. Further, the engagement surface 64 of the rear pair of tabs 38 is preferably at an elevation above the top face 48 of each of the side walls (FIG. 5) so as to simplify manufacturing and maximize the lateral restraint provided by the side walls. Additionally, the gap 58 and spacing 62 are each preferably about equal to or slightly larger than the thickness of the larger hook arm. In the preferred embodiment, where the shim is adapted to accommodate a 9 mm×4 mm hook arm, the dimension of the gap 58 and spacing 62 is preferably slightly larger than the 4 mm nominal thickness of the hook arm. Just as the width 50 defined by the side wall spacing may be varied to accommodate arms of various width, the dimension of the gap 58 and spacing 62 may also be selected to accommodate a hook arm of virtually any dimension.

With the above in mind, it should be understood that the shim 24 may be securely fastened to a hook slot wiper arm by disposing the arm within the gap 58 and spacing 62 (FIG. 8) such that the front and rear pair of tabs 36 and 38 are positioned in operative engagement with the arm. When so assembled, the rear pair of tabs 38 cooperate with the deck 44 and the front pair of tabs 36 cooperate with the arcuate extension 46 to limit movement of the hook arm relative to the shim. The side walls 32 and 34 restrain the hook arm against lateral movement. The resiliency of the side walls, including the wing portions thereof, enhance the coupling of the shim to the hook slot wiper arm while permitting a consumer to remove the shim from the wiper arm when necessary. In fact, the friction fit between the hook arm and side walls may be sufficient for certain shim configurations so as to eliminate the need of the front and rear pair of tabs 36 and 38. However, the illustrated embodiment includes the recited tabs in order to enhance the retention of the shim to the hook arm.

As is best illustrated in FIG. 8, when the shim 24 is coupled to a larger hook arm 12, such as the illustrated 9 mm×4 mm arm, the lower bearing surface 42 of the shim 24 and the upper surface 86 of the hook tail 25 cooperate to create a profile, indicated by the dotted line 88, that approximates the configuration and dimensions of the smaller hook arm for which the connector is designed. For example, in the illustrated embodiment, the spacing 90 between the upper and lower bearing surfaces of the base is approximately 4.1 mm and the radii of the arcuate portions 92 and 94 of the upper and lower bearing surfaces are 5.3 mm and 3.4 mm, respectively. This configuration, in combination with the 10.7 mm tail spacing 96 and 5.4 mm radius of a standard 9 mm×4 mm hook arm, causes the lower bearing surface 42 of the shim 24 and the upper surface 86 of the tail 25 to approximate the profile of a smaller 9 mm×3 mm hook arm.

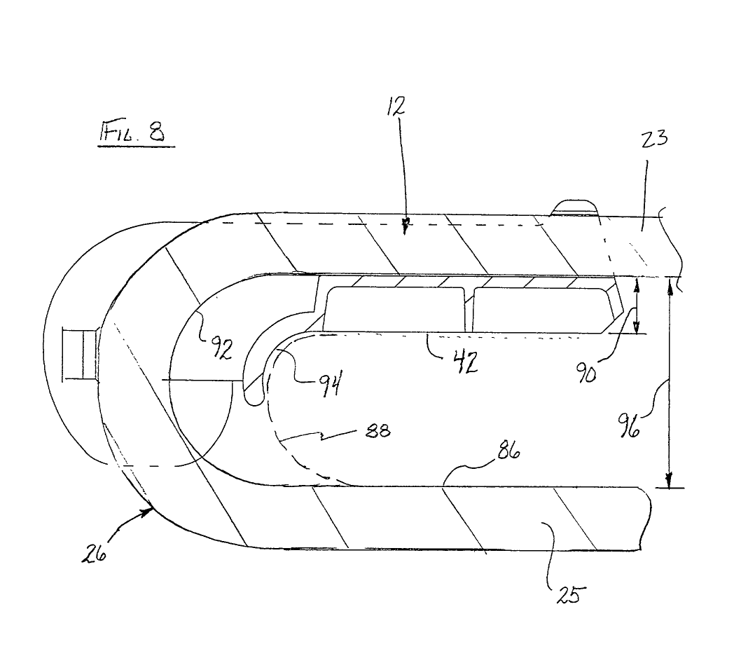

As noted above, the lower bearing surface 42 of the shim 24 is configured to mesh with the channel 20 (FIG. 1) in the connector 18. For the particular application illustrated in the drawings, the lower bearing surface 42 in the area of the rear deck 44 has a constant width 76 (FIG. 7) and is laterally bounded by side faces 78 and 80. The width 76 is approximately 9 mm so as to approximate a smaller 9 mm×3 mm hook arm for which the illustrated connector is configured to accommodate. Similarly, the height of the side faces 78 and 80 may be selected to mesh with the dimensions of the connector, e.g., approximately 3 mm in height to imitate the 3 mm thickness of the smaller 9 mm×3 mm hook arm. Notwithstanding this specific description, those skilled in the art will appreciate that the height of the side faces, as well as the width 76 of the lower bearing surface 42, may be varied to permit the shim to be used with a wide variety of different connectors.

As noted above, the shim 24 is preferably connected to the body 23 and hook 26 of a larger wiper arm 12 (FIGS. 1 and 8) to approximate the configuration and dimensions of a smaller hook arm for which the connector 18 is designed. The shim and hook arm are then connectable to the connector 18 to couple the wiper arm to the windshield wiper blade. More particularly, when assembled, the shim 24 is positioned such that the deck 44 is disposable between the body 23 of the hook arm 12 and the channel 20 of the connector 18. In this configuration, the lower bearing surface 42 and the tail 25 of the hook arm are spaced to receive the connector 18 therebetween.

Those skilled in the art will appreciate that the scope of the invention is not limited to the specific embodiment illustrated and described herein nor to the specific dimensions provided for exemplary purposes. In fact, the foregoing discussion discloses and describes only an exemplary embodiment of the present invention. One skilled in the art will readily recognize from such discussion, and from the accompanying drawings and claims that various changes, modifications and variations can be made therein without departing from the true spirit and fair scope of the invention as defined by the following claims.

What is claimed is:

1. A shim for a wiper arm for a windshield wiper blade assembly, said shim comprising:
a base including a deck and an arcuate extension extending from said deck, said base defining a hook shaped upper bearing surface and a hook shaped lower bearing surface;
first and second side walls extending from said base and spaced from one another to define a channel; and
a first pair of opposed tabs extending from said side walls into said channel for coupling said shim to a wiper arm.

2. The shim of claim 1 wherein said each of said side walls include a wing segment extending forward of said arcuate extension and wherein said first pair of opposed tabs extend inward from each wing segment.

3. The shim of claim 2 wherein said first pair of opposed tabs are positioned below said upper bearing surface.

4. The shim of claim 2 further including a second pair of opposed tabs extending from said side walls into said channel.

5. The shim of claim 4 wherein said second pair of opposed tabs extend inward from said side walls above said deck.

6. The shim of claim 5 wherein said second pair of opposed tabs each include an engagement face positioned substantially parallel to said deck and defining a spacing between said engagement fact and said deck.

7. The shim of claim 6 wherein said side walls terminate at a top face, wherein said second pair of opposed tabs project upward from said top face, and wherein said engagement faces are positioned at an elevation no lower than said top face.

8. The shim of claim 1 wherein said first pair of opposed tabs extend inward from said side walls above said deck and wherein said first pair of opposed tabs each include an engagement face positioned substantially parallel to said deck.

9. The shim of claim 8 further including a second pair of opposed tabs extending from said side walls into said channel, wherein each of said side walls include a wing segment extending forward of said arcuate extension, and wherein said second pair of opposed tabs extend inward from wing segments.

10. A wiper arm assembly for connecting a wiper blade to a wiper drive motor, said wiper arm assembly comprising:
a wiper arm having a hook defining a body segment, a curve, and a tail, said tail being spaced a first distance from the body segment to define an inner diameter of said curve;
a shim having a base and first and second side walls spaced from one another and fixed to the base, said base having a first bearing surface and a second bearing surface parallel to and spaced from said first bearing surface, said base further including an arcuate extension partially defining said first and second bearing surfaces, said first bearing surface being recessed from a top face of the side walls to define a channel between said side walls, said channel having a width defined by the side wall spacing, said shim being attached to the second end of the wiper arm so that said second bearing surface is spaced from the lower body surface, said second bearing surface and said upper tail surface defining a coupling profile that approximates the configuration of a smaller hook arm to permit coupling of the larger hook arm to the wiper blade.

11. The wiper arm assembly of claim 10 wherein the shim is directly attached to said hook arm.

12. The wiper arm assembly of claim 10 wherein said shim includes a first pair of opposed tabs extending from said side walls into said channel for coupling said shim to the wiper arm.

13. The wiper arm assembly of claim 12 wherein said each of said side walls include a wing segment extending forward of said arcuate extension and wherein said first pair of opposed tabs extend inward from each wing segment.

14. The wiper arm assembly of claim 13 wherein said shim further includes a second pair of opposed tabs extending from said side walls into said channel, wherein each of said side walls include a wing segment extending forward of said arcuate extension, and wherein said second pair of opposed tabs extend inward from said wing segments.
